(19) United States
(12) Patent Application Publication
(10) Pub. No.: US 2026/0102226 A1
(43) Pub. Date: Apr. 16, 2026

(54) ORTHODONTIC ATTACHMENT WITH CANTILEVERED HOOK

(71) Applicant: Zhi Chun Song, Anmore (CA)

(72) Inventor: Zhi Chun Song, Anmore (CA)

(21) Appl. No.: 18/912,197

(22) Filed: Oct. 10, 2024

(51) Int. Cl. A61C 7/36

(52) U.S. Cl. CPC A61C 7/36

(57) ABSTRACT

An orthodontic hook is attachable to one of a tooth surface and an orthodontic appliance. The hook includes a base pad attachable to the tooth surface and a hook body comprising a connection part projecting from the base pad and a cantilevered part extending laterally from the connection part. The cantilevered part includes first and second members separated from each other by a slot, and includes a joint member next to the connection part for connecting between the first member and the second member. The first member defines a first extremity which is maximally proximate to the second member and defines a third extremity which is maximally distal from the joint member. A first end of the first member forms a first protrusion protruding toward the second member that tapers from the third extremity to the first extremity. A slot constriction forms between the first extremity and the second member.

### BACKGROUND OF THE INVENTION

### 1. Field of Invention

This invention relates to dentistry and, in particular, to an orthodontic attachment or appliance forming a hook.

### 2. Description of Related Art

While braces and aligners straighten teeth, they do not align the bite. Dental elastics may be used in conjunction with either braces or aligners to treat malocclusion, or a misaligned bite. Other orthodontic appliances like the known Carriere® Motion appliance may also use elastic rubber bands to correct the relationship between the upper and lower jaws.

Currently, there are many attachment options available for elastic rubber bands. Such conventional attachment options are referred to as elastic hooks. It can be difficult to install an elastic hook when a patient has short crowns. In some cases, the aligner cannot control the tooth position after a cutout has been made for the elastic hook. In other cases, the elastic hook is not close to the resistance center of the tooth such that the tooth does not readily move bodily. For these reasons, an improved elastic hook is proposed herein to solve these problems.

### SUMMARY

The above shortcomings may be addressed by providing an orthodontic hook attachable to one of a tooth surface and an orthodontic appliance. The hook comprises: (a) a base pad attachable to one of the tooth surface and the orthodontic appliance; and (b) a hook body comprising a connection part projecting from the base pad, and a cantilevered part extending laterally from the connection part, the cantilevered part including a first member and a second member separated from the first member by a slot formed in the cantilevered part, the cantilevered part further including a joint member disposed next to the connection part. The joint member is connected between the first member and the second member. The joint member is disposed at an end of the slot. The first member defines a first extremity which is maximally proximate to the second member and defines a third extremity which is maximally distal from the joint member. A first end of the first member forms a first protrusion protruding toward the second member. The first protrusion has a tapered shape and tapers to the first extremity, and a slot constriction forms between the first extremity and the second member.

A second distance between the first extremity and the second member may be less than 1.0 mm. A third distance between the third extremity and the first extremity may be at least 0.6 mm. The second member defines a fourth extremity which is maximally distal from the joint member. The first and second members define a slot opening formed between the third extremity and the fourth extremity. The slot may narrow from the slot opening to the slot constriction and may widen from slot constriction to a slot center defined by the cantilevered part. A first distance between the third extremity and the fourth extremity may be larger by at least 1.8 times than the second distance between the first extremity and the second member. A second end of the second member may form a second protrusion protruding toward the first member. The second protrusion may have a tapered shape and may taper to a second extremity, of the second member, which is maximally proximate to the first member. The second member may define a fourth extremity which is maximally distal from the joint member. A second end of the second member may form a second protrusion protruding toward the first member. The second protrusion may taper to a second extremity, of the second member, which is maximally proximate to the first member. A fourth distance between the fourth extremity and the second extremity may be at least 0.6 mm.

In accordance with another aspect of the invention, there is provided an orthodontic hook attachable to one of a tooth surface and an orthodontic appliance. The hook comprises: (a) a base pad attachable to one of the tooth surface and the orthodontic appliance; and (b) a hook body comprising a connection part projecting from the base pad, and a cantilevered part extending laterally from the connection part, the cantilevered part including a first member and a second member separated from the first member by a slot formed in the cantilevered part, the cantilevered part further including a joint member disposed next to the connection part. The joint member is connected between the first member and the second member. The joint member is disposed at an end of the slot. The first member defines a first extremity which is maximally proximate to the second member and defines a third extremity which is maximally distal from the joint member. The second member defines a second extremity which is maximally proximate to the first member and defines a fourth extremity which is maximally distal from the joint member. A slot opening is formed between the third extremity and the fourth extremity, and a slot constriction is formed between the first extremity and the second extremity. The slot narrows from the slot opening to the slot constriction and widens from the slot constriction to a slot center.

A first end of the first member may form a first protrusion protruding toward the second member. The first protrusion may have a tapered shape and taper from the third extremity to the first extremity. A second end of the second member may form a second protrusion protruding toward the first member. The second protrusion may have a tapered shape and taper from the fourth extremity to the second extremity. A second distance between the first extremity and the second member may be less than 1.0 mm. A third distance between the third extremity and the first extremity may be at least 0.6 mm. A first distance between the third extremity and the fourth extremity may be larger by at least 1.8 times than a second distance between the first extremity and the second member. A fourth distance between the fourth extremity and the second extremity may be at least 0.6 mm.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

Various objects, features and advantages of the invention will be apparent from the following description of embodiments of the invention, as illustrated in the accompanying drawings. The drawings are not necessarily to scale, emphasis instead being placed upon illustrating the principles of various embodiments of the invention.

FIG. 1 is a perspective view of a first embodiment of an orthodontic hook.

FIG. 2 is a top view of the first embodiment of the orthodontic hook.

FIG. 3 is a side view of the first embodiment of the orthodontic hook.

FIG. 4 is a perspective view of a second embodiment of an orthodontic hook.

FIG. 5 is a top view of the second embodiment of the orthodontic hook.

FIG. 6 is a side view of the second embodiment of the orthodontic hook.

FIG. 7 is a perspective view of a third embodiment of an orthodontic hook.

FIG. 8 is a top view of the third embodiment of the orthodontic hook.

FIG. 9 is a side view of the third embodiment of the orthodontic hook.

FIG. 10 is a perspective view of a fourth embodiment of an orthodontic hook, showing that the connection part is a bracket with two arch wire slots.

FIG. 11 is a top view of the fourth embodiment of the orthodontic hook.

FIG. 12 is a side view of the fourth embodiment of the orthodontic hook.

### DETAILED DESCRIPTION

An apparatus for retaining an elastic band includes: (a) means for receiving the elastic band; (b) means for guiding the elastic band to pass a slot constriction and enter the slot center, the width of a slot constriction being less than 1.0 mm; (c) means for engaging with an aligner to arrange the teeth; and (d) means for arranging a slot in a cantilevered part of the apparatus.

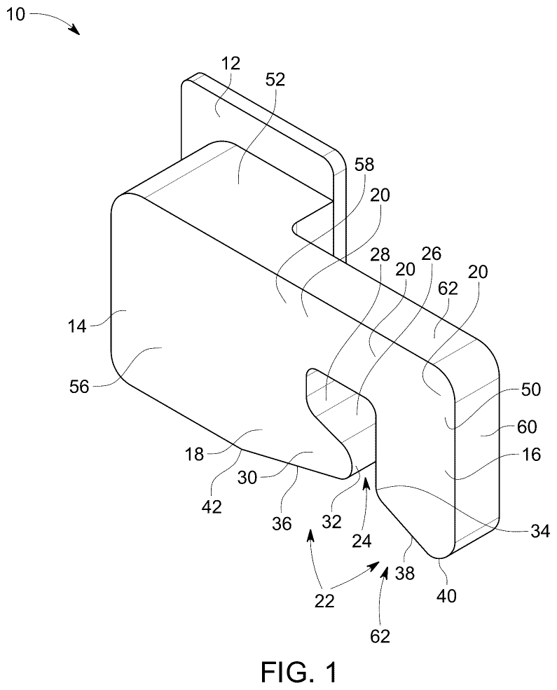

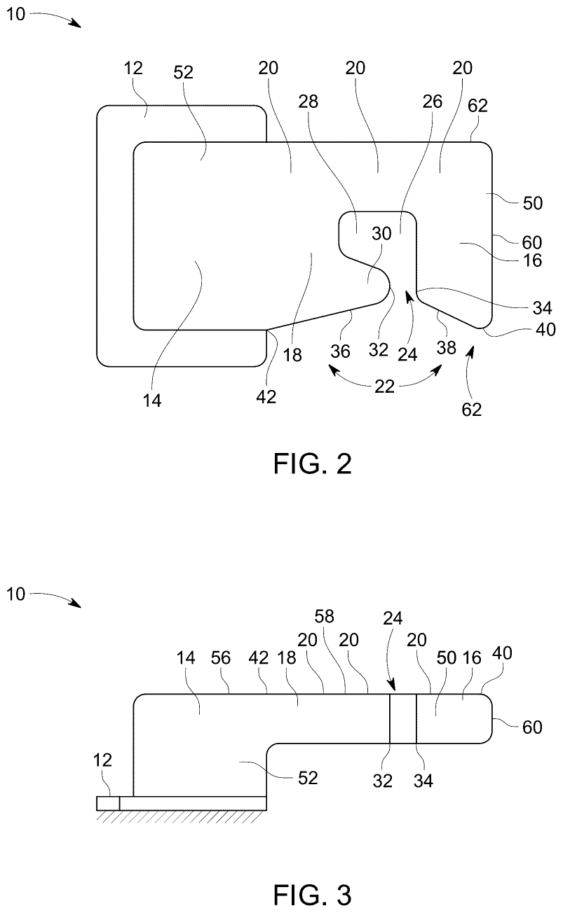

FIG. 1 is a perspective view of the first embodiment of an orthodontic hook, and FIG. 2 is a top view of the first embodiment of the orthodontic hook 10. The orthodontic hook 10 is attachable to one of a tooth surface (not shown) and an orthodontic appliance (not shown). The hook 10 includes a base pad 12 that is attachable to the tooth surface. In some circumstances, the base pad 12 is instead attached to an orthodontic appliance. The base pad 12 may have different shapes, like a circle, a rectangle, an oval, or an irregular shape. In the first embodiment, the outer surface of this base pad 12 for cementing with the tooth surface is a flat surface. In some embodiments, the base pad 12 has a curved surface conforming to the tooth surface.

The orthodontic hook 10 includes a hook body 52 that includes a connection part 14 projecting from the base pad 12. A cantilevered part 50 of the hook body 52 extends laterally from the connection part 14. The connection part 14 can be the orthodontic appliance such as a Carriere® Motion Appliance, Buccal Tube, Attachment, or Bracket etc. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 connects the first member 18 to the second member 16, and the joint member 20 is placed between the first member 18 and the second member 16. The joint member 20 is disposed at the end of the slot 28. The end of the first member 18 forms a first protrusion 30 protruding toward the second member 16. The first protrusion 30 has a tapered shape and tapers to a first extremity 32, of the first member 18, which is maximally proximate to the second member 16. The first extremity 32 is also the end 32 of the first protrusion 30 in this embodiment. A second extremity 34 of the second member 16 is maximally proximate to the first member 18, a slot constriction 24 is formed in and defined by the cantilevered part 50 between the first extremity 32 and the second member, and the slot constriction 24 extends between the first extremity 32 and the second extremity 34. The slot 28 has a slot opening 22 at one of the side surfaces 62 of the cantilevered part 50 in this embodiment. However, in other embodiments the slot opening 22 may be located at the other side surface 62 or at the end surface 60 of the cantilevered part 50. The first member 18 defines a third extremity 42 which is maximally distal from the joint member 20, and the second member 16 defines a fourth extremity 40 which is maximally distal from the joint member 20. The slot opening 22 extends between the third extremity 42 and the fourth extremity 40. The slot center 26 is surrounded by the first member 18, the second member 16, the joint member 20, and the first protrusion 30. The slot 28 narrows from the slot opening 22 to the slot constriction 24 and widens from the slot constriction 24 to the slot center 26. A first guiding surface 36 is formed between the third extremity 42 and the first extremity 32, and a second guiding surface 38 is formed between the fourth extremity 40 and the second extremity 34. The narrow slot constriction 24 and the big slot opening 22 makes the guiding surfaces 36 and 38 advantageously long. After the slot opening 22 catches the elastic rubber band (not shown), the elastic rubber band can be readily guided into the narrow slot constriction 24. These big guiding surfaces 36 and 38 make the narrow slot constriction 24 advantageously functional in the clinic, and at the same time the hook 10 is minimally irritating and advantageously inhibits the elastic rubber band from unintentionally escaping when the elastic rubber band is pulled in different directions. In some embodiments, the end of the second member 16 may form a protrusion protruding toward first member 18, the protrusion may have a tapered shape and taper to the second extremity 34, and no protrusion protruding toward the second member 16 is formed at the end of the first member 18. Except where otherwise indicated, the second member 16 may have any features of the first member 18 in any given embodiment. Additionally or alternatively, the first member 18 may have any features of the second member 16 in any given embodiment. The protrusion 30 of the first member 18 has a tapered shape with a gradual reduction in cross-sectional area such that the protrusion 30 tapers from the third extremity 42 to first extremity 32.

A slot opening 22 is formed between the third extremity 42 and the fourth extremity 40. A slot constriction 24 is formed between the first extremity 32 and the second member 16. A first distance between the third extremity 42 and the fourth extremity 40 is larger by at least 2 times than the second distance between the first extremity 32 and the second member 16. The first distance is also the width of the slot opening 22, the second distance is also the width of the slot constriction 24. In some embodiments, the first distance is larger than the second distance by at least 1.8 times. The first distance is at least 1.5 mm in the first embodiment. The second distance is less than 1.0 mm in the first embodiment. In some embodiments, the second distance is less than 0.8 mm. In some embodiments, the second distance is less than 0.6 mm. The second distance is also the distance from the first extremity 32 to the second extremity 34 in some embodiments, and the second distance is also the distance from the second extremity 34 to the first member 18 in such embodiments. The third distance between the third extremity and the first extremity is at least 0.8 mm in the first embodiment. The fourth distance between the fourth extremity and the second extremity is at least 0.8 mm in the first embodiment. In some embodiments, the third distance is at least 0.6 mm, and in some embodiments the fourth distance is at least 0.6 mm.

The slot 28 narrows continuously from the slot opening 22 to the slot constriction 24 in the first embodiment. The relatively wider slot opening 22 is very helpful to catch the elastic rubber band (not shown) in the very beginning of a process of inserting the rubber band into the slot 28. The constriction 24 is useful for preventing the elastic rubber band from unintentionally falling off or otherwise unintentionally exiting the slot 28. The elastic rubber band must be pulled in a certain direction to remove the elastic rubber band from the orthodontic hook 10 in this embodiment. The relatively large and smooth guiding surfaces 36 and 38 have no sharp edges so as to minimally irritate the tongue and the buccal mucosa. The orthodontic hook 10 can be made of metal, plastic, ceramic, composite resin, or any other suitable materials for example.

The connection part 14 can act as an attachment for aligner treatment to improve an aligner's control of tooth movement, especially for canine teeth (typically of a human patient). By using the orthodontic hook 10, the aligner (not shown) can cover the connection part 14 of the hook 10 and the connection part 14 may have an attachment formation (not shown). In various embodiments, the aligner (not shown) does not need a cutout to place an orthodontic hook 10. When the hook 10 is cemented on a tooth crown, the cantilevered part 50 and the slot 28 may be directly above the tooth root and the elastic rubber band placed on the orthodontic hook 10 is advantageously close to the resistance center of the tooth, therefore orthodontic hook 10 facilitates the tooth having an improved chance to do bodily movement. The hook 10 can be smooth to minimally irritate the tongue and mucosa. In some embodiments, the end of the second member 16 forms a second protrusion protruding toward the first member 18, no protrusion protruding toward the second member 16 is present at the end of the first member 18, and the slot constriction 24 is formed between the second protrusion of the second member 16 and the first member 18.

FIG. 3 is a side view of the first embodiment of the orthodontic hook 10. FIGS. 1 and 3 show the cantilevered part 50 is not directly above the base pad 12. In some embodiments, part of the cantilevered part 50 is directly above the base pad 12. In some embodiments, the entire cantilevered part 50 is directly above the base pad 12. The top surface 56 of the connection part 14 and the top surface 58 of the cantilevered part 50 is on a same plane (i.e. are coplanar). In this embodiment, the top surface 56 of the connection part 14 and the top surface 58 of the cantilevered part 50 are at the same vertical height above the base pad 12. In other embodiments, the top surface of different parts of the hook body 52 may not be at the same vertical height above the base pad 12.

An elastic band (not shown) engaged with the orthodontic hook 10 in an orthodontic treatment may have a first thickness when stretched and a second (typically larger) thickness when relaxed. The second distance of the slot constriction 24 is preferably less than the second thickness of the elastic band, but greater than the first thickness of the elastic band. The second thickness of elastic bands used in orthodontic treatment is typically larger than 1.0 mm. The second distance D2 is less than 1.0 mm in the first embodiment. The first distance of the slot opening 22 is preferably greater than the second thickness of the elastic band such that the slot opening 22 may catch the elastic band, and the elastic band having the first thickness when stretched by a force F may slide along the guiding surfaces 36 and 38 and pass the slot constriction 24, thereafter entering the slot center 26. The slot constriction 24 may be dimensioned to impede, but not prevent, removal of an elastic band from the slot center 26.

Unless otherwise stated herein, each distance from a point to a surface is the shortest distance from the point to the surface, and each distance between two points is the shortest distance between these two points. Unless otherwise stated herein, height refers to a perpendicular distance from a point at a certain part of the top surface to an ideal plane of the base pad 12.

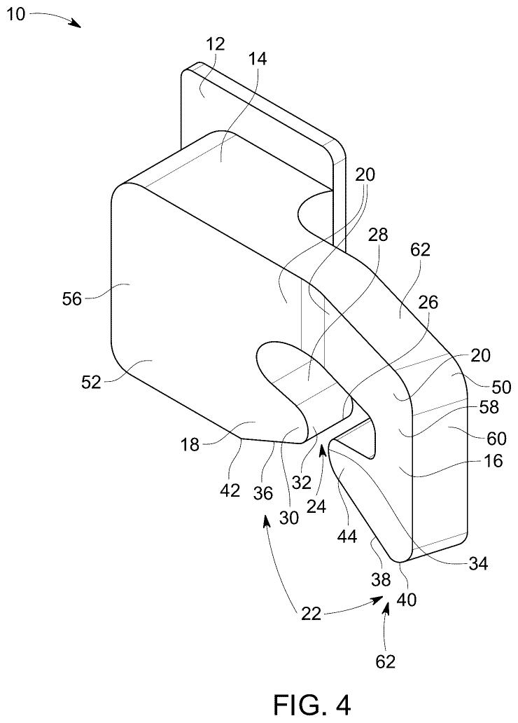

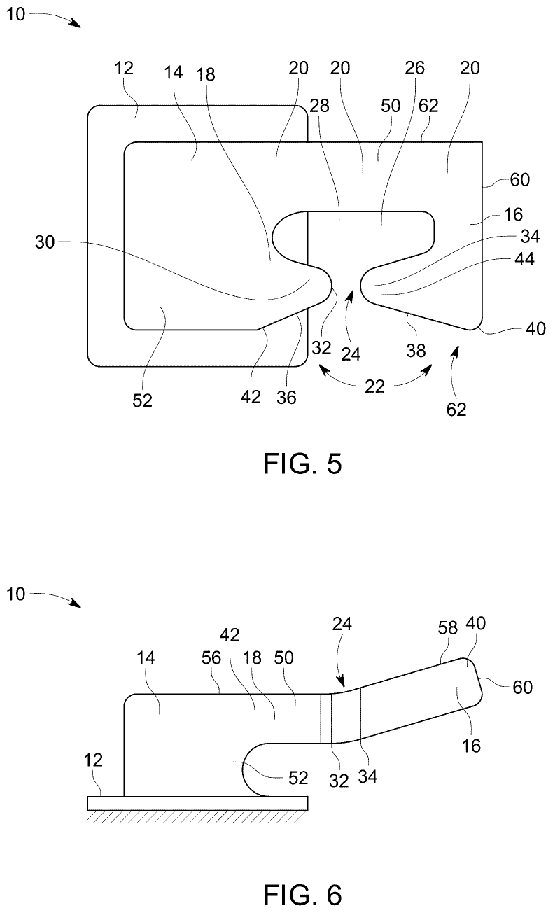

FIG. 4 is a perspective view of a second embodiment of the orthodontic hook, and FIG. 5 is a top view of the second embodiment of the orthodontic hook 10. The second embodiment is similar to the first embodiment. For example, the orthodontic hook 10 is attachable to one of a tooth surface (not shown) and an orthodontic appliance (not shown). The hook 10 includes a base pad 12 that is attachable to a tooth surface. The orthodontic hook 10 includes a hook body 52 that includes a connection part 14 projecting from the base pad 12. A cantilevered part 50 of the hook body 52 extends laterally from the connection part 14. The connection part 14 can be the orthodontic appliance such as a Carriere® Motion Appliance, Buccal Tube, Attachment, or Bracket etc. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 connects to the first member 18 and the second member 16, and the joint member 20 is placed between the first member 18 and the second member 16. The joint member 20 is disposed at the end of the slot 28.

One of the differences between the first and second embodiments is that the end of the second member 16 in the second embodiment forms a second protrusion 44 protruding toward the first member 18. The second protrusion 44 has a tapered shape and tapers to the second extremity 34 of the second member 16. In this second embodiment, the first protrusion 30 extends toward the second member 16 from the first member 18, and the second protrusion 44 extends toward the first member 18 from the second member 16, such that the slot constriction 24 is formed between the end 32 of the first protrusion 30 and the end 34 of the second protrusion 44. The slot 28 narrows from the slot opening 22 to the slot constriction 24. Between the slot opening 22 and the slot constriction 24, a first guiding surface 36 is at the first protrusion 30 and a second guiding surface 38 is at the second protrusion 44. The second protrusion 44 also has a tapered shape tapering to the end 34 of the second protrusion 44; the end 34 is also the second extremity 34, of the second member 16, which is maximally proximate to the first member 18; and the end 32 is also the first extremity 32 of the first member 18. The slot constriction 24 is formed between the first extremity 32 and the second extremity 34 in the second embodiment. The slot center 26 is surrounded by the first member 18, the second member 16, the joint member 20, the first protrusion 30, and the second protrusion 44. The first member 18 defines a third extremity 42 which is maximally distal from the joint member 20, and the second member 16 defines a fourth extremity 40 which is maximally distal from the joint member 20. In this second embodiment, the slot opening 22 is located at one of the side surfaces 62 of the cantilevered part 50. Alternatively, the slot opening 22 may be located at the other side surface 62, or at the end surface 60 of the cantilevered part 50 in other embodiments.

A slot opening 22 is formed between the third extremity 42 and the fourth extremity 40. The slot constriction 24 is formed between the first extremity 32 and the second extremity 34 in the second embodiment. A first distance between the third extremity 42 and the fourth extremity 40 is larger by at least 2 times than the second distance between the first extremity 32 and the second member 16. In some embodiments, the first distance is larger than the second distance by at least 1.8 times. The first distance is at least 1.5 mm in the second embodiment. The second distance is less than 1.0 mm in the second embodiment. In some embodiments, the second distance is less than 0.8 mm. In some embodiments, the second distance is less than 0.6 mm. In the second embodiment, the second distance is also the distance from the first extremity 32 to the second extremity 34, and the second distance is also the distance from the second extremity 34 to the first member 18. The third distance between the third extremity and the first extremity is at least 0.8 mm in the second embodiment. The fourth distance between the fourth extremity and the second extremity is at least 0.8 mm in the second embodiment. In some embodiments, the third distance is at least 0.6 mm, while in some embodiments the fourth distance is at least 0.6 mm.

FIG. 6 is a side view of the second embodiment of the orthodontic hook 10. FIGS. 4 and 6 show that part of the top surface 58 of the cantilevered part 50 is further vertically from the lower plane of the base pad 12 than is the top surface 56 of the connection part 14. In this embodiment, the top surfaces of different parts of the hook body 52 are at different heights above the base pad 12. Part of the cantilevered part 50 next to the connection part 14 is directly above the base pad 12. However, the slot constriction 24 is not directly above the base pad 12. Part of the slot center 26 is directly above the base pad 12.

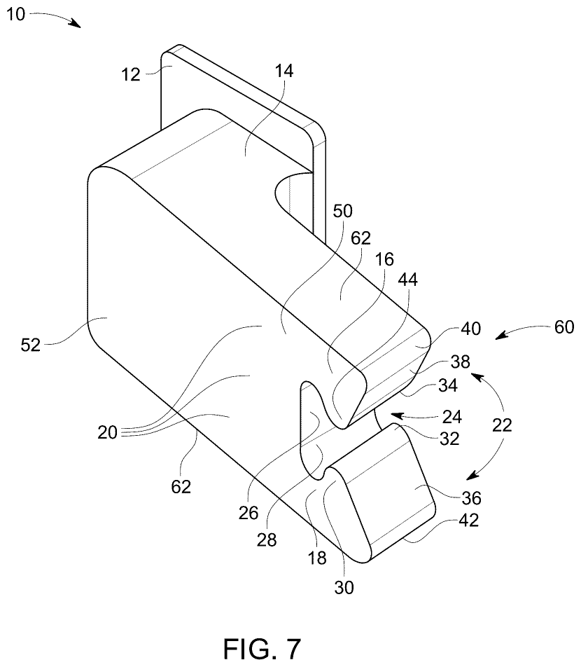

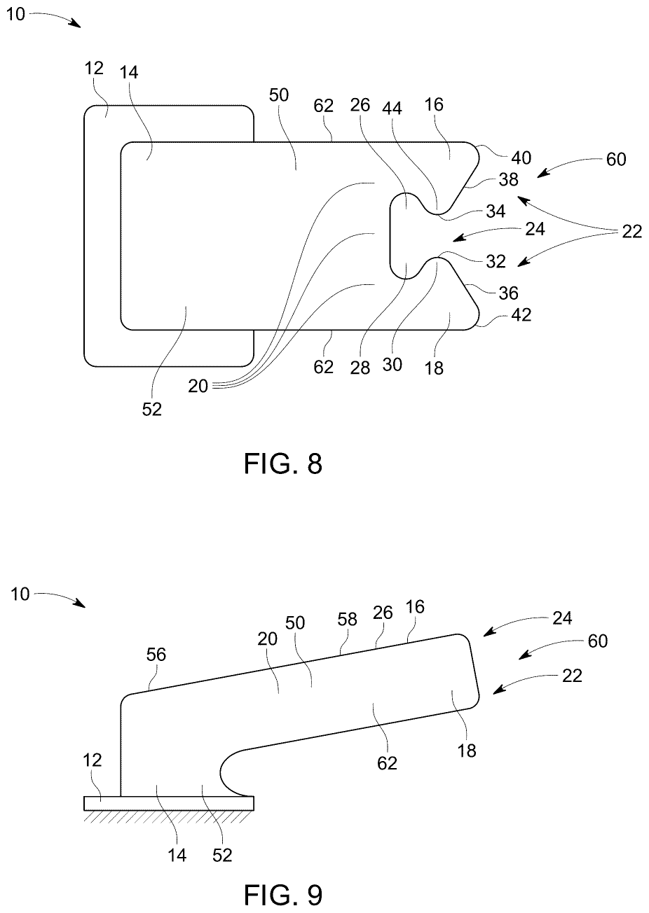

FIG. 7 shows a perspective view of a third embodiment of the orthodontic hook 10. FIG. 8 shows a top view of the third embodiment of the orthodontic hook 10. In this embodiment, the orthodontic hook 10 is attachable to one of a tooth surface (not shown) and an orthodontic appliance (not shown). The hook 10 includes a base pad 12 that is attachable to the tooth surface. The orthodontic hook 10 also includes a hook body 52. The hook body 52 includes a connection part 14 projecting from the base pad 12 and includes a cantilevered part 50. The cantilevered part 50 extends laterally from the connection part 14. The cantilevered part 50 comprises a first member 18, a second member 16, and a joint member 20. A slot 28 is formed in the cantilevered part 50, and the first member 18 and the second member 16 are separated from each other by the slot 28. The joint member 20 next to the connection part 14 is connected to the first member 18 and the second member 16, and the joint member 20 is placed between the first member 18 and the second member 16. The joint member 20 is disposed at the end of the slot 28. The third embodiment is similar to the second embodiment, and one of the differences between these two embodiments is that the slot opening of the third embodiment is located at the end surface 60 of the cantilevered part 50. The slot constriction 24 is also located at the end surface 60 of the cantilevered part 50 in the third embodiment. This third embodiment provides a different place for receiving the elastic rubber band (not shown). The elastic rubber band in this hook 10 can receive the dragging force from the mesial or distal direction, for example.

The first member 18 defines a third extremity 42 which is maximally distal from the joint member 20 and defines a first extremity 32 which is maximally proximate to the second member 16, and the second member 16 defines a fourth extremity 40 which is maximally distal from the joint member 20 and defines a second extremity 34 which is maximally proximate to the first member 18. A slot constriction 24 is formed between the first extremity 32 and the second extremity 34. The slot 28 has a slot opening 22 at the distal surface 60 of the cantilevered part 50. The slot opening 22 extends between the third extremity 42 and the fourth extremity 40. The slot center 26 is surrounded by the first member 18, the second member 16, the joint member 20, the first protrusion 30, and the second protrusion 44. The slot 28 narrows from the slot opening 22 to the slot constriction 24 and widens from the slot constriction 24 to the slot center 26. A first guiding surface 36 is formed between the third extremity 42 and the first extremity 32, and a second guiding surface 38 is formed between the fourth extremity 40 and the second extremity 34. The end of the first member 18 forms a protrusion 30 which has a tapered shape with a gradual reduction in cross-sectional area and which tapers from the third extremity 42 to first extremity 32. The end of the second member 16 forms a protrusion 44 which has a tapered shape with a gradual reduction in cross-sectional area such that the protrusion 44 tapers from the fourth extremity 40 to second extremity 34.

A slot opening 22 is formed between the third extremity 42 and the fourth extremity 40. A slot constriction 24 is formed between the first extremity 32 and the second extremity 34 of the second member 16. A first distance of the slot opening 22 between the third extremity 42 and the fourth extremity 40 is larger by at least 2 times than the second distance of the slot constriction 24 between the first extremity 32 and the second extremity 34. In some embodiments, the first distance is larger than the second distance by at least 1.8 times. The first distance is at least 1.5 mm in the third embodiment. The second distance is less than 1.0 mm in the third embodiment. In some embodiments, the second distance is less than 0.8 mm. In some embodiments, the second distance is less than 0.6 mm. In the third embodiment, the second distance is also the distance from the first extremity 32 to the second member 16, and the second distance is also the distance from the second extremity 34 to the first member 18. The third distance between the third extremity and the first extremity is at least 0.8 mm in the third embodiment. The fourth distance between the fourth extremity and the second extremity is at least 0.8 mm in the third embodiment. In some embodiments, the third distance is at least 0.6 mm, while in some embodiments the fourth distance is at least 0.6 mm.

FIG. 9 is a side view of the third embodiment of the orthodontic hook 10, which shows that the top surface 56 of the connection part 14 and the top surface 58 of the cantilevered part 50 are not at the same height above the lower plane of the base pad 12. The top surface 58 of the cantilevered part 50 is further away from the base pad 12 plane than the top surface 56 of the connection part 14, such that the perpendicular distance from a point at the top surface 58 to the base pad 12 plane is larger than the perpendicular distance from a point at the top surface 56 to the base pad 12 plane. Only part of the cantilevered part 50 is directly above the base pad 12.

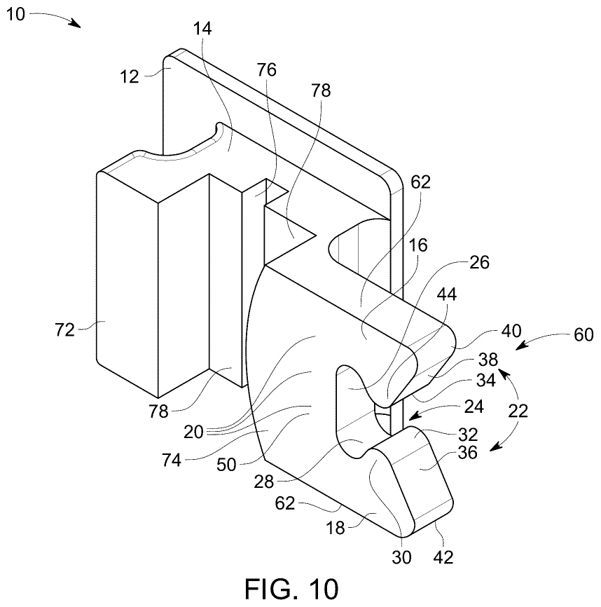

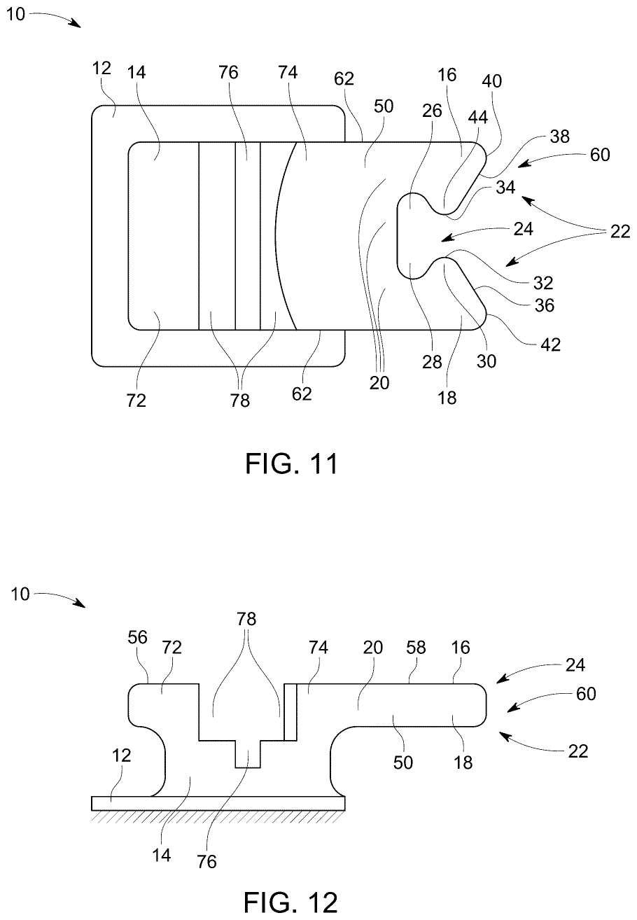

FIG. 10 is a perspective view of a fourth embodiment of the orthodontic hook. FIG. 11 is a top view of the fourth embodiment of the orthodontic hook 10. This fourth embodiment is similar to the third embodiment, and one of the differences between these two embodiments is that the connection part 14 of the fourth embodiment is a bracket with two arch wire slots (76 and 78). The two arch wire slots comprise the first rectangular arch wire slot 76 at the lingual side with an opening toward the second arch wire slot 78 at the labial side. The first arch wire slot 76 is smaller than the second arch wire slot 78. Also, the cross sections of the second arch wire slot 78 are bigger at the mesial and distal sides than at the middle portion of the second arch wire slot 78. These two arch wire slots are defined by an occlusal member 72 of the bracket and a gingival member 74 of the bracket. Also, part of the gingival member 74 is the cantilevered part 50. Part of the cantilevered part 50 is directly above the base pad 12. A slot 28 formed in the cantilevered part has an opening 22 at the distal surface 60 of the cantilevered part 50, and a slot constriction 24 is formed between the first extremity 32 and the second extremity 34.

FIG. 12 is a side view of the fourth embodiment of the orthodontic hook 10, which shows the first arch wire slot 76 is at the lingual side of the second arch wire slot 78 and has an opening toward the second arch wire slot 78. Also, the cross section of the first arch wire slot 76 is smaller than the cross section of the second arch wire slot 78. The cross section of the first arch wire slot 76 has a rectangular shape, and the cross section of the second arch wire slot 78 has a bigger rectangular area than the first arch wire slot 76. The cantilevered part 50 is also part of the gingival member 74 of the bracket. Only part of the cantilevered part 50 is directly above the base pad 12 in the fourth embodiment.

In variations of all the embodiments, each of the first extremity, second extremity, third extremity and fourth extremity may form a single point, line, or area, for example.

Various features have been described and illustrated in association with specific embodiments of the invention. Except where an incompatible combination of features would result, any feature described or illustrated in association with a particular embodiment herein may be employed with any other embodiment described or illustrated herein.

### REFERENCE CHARACTERS ASSOCIATED WITH THE DRAWINGS

Orthodontic hook 10
Base pad 12
Connection part of hook body 14
Second member of Cantilevered Part 16
First member of Cantilevered Part 18
Joint member of Cantilevered Part 20
Slot Opening 22
Slot Constriction 24
Slot Center 26
Slot 28
First Protrusion 30
First extremity 32
Second extremity 34
First guiding surface 36
Second guiding surface 38
Fourth extremity 40
Third extremity 42
Second protrusion 44
Cantilevered part 50
Hook Body 52
Top surface of the connection part 56
Top surface of the cantilevered part 58
End surface of the cantilevered part 60
Side surface of the cantilevered part 62
Occlusal member of the bracket 72
Gingival member of the bracket 74
First arch wire slot 76
Second arch wire slot 78

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. An orthodontic hook attachable to one of a tooth surface and an orthodontic appliance, the hook comprising:
(a) a base pad attachable to one of the tooth surface and the orthodontic appliance; and
(b) a hook body comprising a connection part projecting from the base pad, and a cantilevered part extending laterally from the connection part, the cantilevered part comprising a first member and a second member separated from the first member by a slot formed in the cantilevered part, the cantilevered part further comprising a joint member disposed next to the connection part, the joint member being disposed at an end of the slot for connecting between the first member and the second member, the first member defining a first extremity which is maximally proximate to the second member, the first member defining a third extremity which is maximally distal from the joint member, a first end of the first member forming a first protrusion protruding toward the second member, the first protrusion having a tapered shape and tapering to the first extremity, a slot constriction being defined between the first extremity and the second member.

2. The orthodontic hook of claim 1 wherein a second distance between the first extremity and the second member is less than 1.0 mm.

3. The orthodontic hook of claim 1 wherein a third distance between the third extremity and the first extremity is at least 0.6 mm.

4. The orthodontic hook of claim 2 wherein the second member defines a fourth extremity which is maximally distal from the joint member, and wherein the first and second members define a slot opening between the third extremity and the fourth extremity, the slot narrowing from the slot opening to the slot constriction and widening from the slot constriction to a slot center defined by the cantilevered part.

5. The orthodontic hook of claim 4 wherein a first distance between the third extremity and the fourth extremity is larger by at least 1.8 times than the second distance between the first extremity and the second member.

6. The orthodontic hook of claim 4 wherein a second end of the second member forms a second protrusion protruding toward the first member, and wherein the second protrusion has a tapered shape and tapers to a second extremity, of the second member, which is maximally proximate to the first member.

7. The orthodontic hook of claim 1 wherein a second end of the second member forms a second protrusion protruding toward the first member, and wherein the second protrusion has a tapered shape and tapers to a second extremity, of the second member, which is maximally proximate to the first member.

8. The orthodontic hook of claim 6 wherein a fourth distance between the fourth extremity and the second extremity is at least 0.6 mm.

9. An orthodontic hook attachable to one of a tooth surface and an orthodontic appliance, the hook comprising:
(a) a base pad attachable to one of the tooth surface and the orthodontic appliance; and
(b) a hook body comprising a connection part projecting from the base pad, and a cantilevered part extending laterally from the connection part, the cantilevered part comprising a first member and a second member separated from the first member by a slot formed in the cantilevered part, the cantilevered part further comprising a joint member disposed next to the connection part, the joint member being disposed at an end of the slot for connecting between the first member and the second member, the first member defining a first extremity which is maximally proximate to the second member, the first member further defining a third extremity which is maximally distal from the joint member, the second member defining a second extremity which is maximally proximate to the first member, the second member further defining a fourth extremity which is maximally distal from the joint member, a slot opening being defined between the third extremity and the fourth extremity, a slot constriction being defined between the first extremity and the second extremity, the slot narrowing from the slot opening to the slot constriction and widening from the slot constriction to a slot center.

10. The orthodontic hook of claim 9 wherein a first end of the first member forms a first protrusion protruding toward the second member, and wherein the first protrusion has a tapered shape and tapers from the third extremity to the first extremity.

11. The orthodontic hook of claim 10 wherein a second end of the second member forms a second protrusion protruding toward the first member, and wherein the second protrusion has a tapered shape and tapers from the fourth extremity to the second extremity.

12. The orthodontic hook of claim 9 wherein a second distance between the first extremity and the second member is less than 1.0 mm.

13. The orthodontic hook of claim 9 wherein a first distance between the third extremity and the fourth extremity is larger by at least 1.8 times than a second distance between the first extremity and the second member.

14. The orthodontic hook of claim 9 wherein a third distance between the third extremity and the first extremity is at least 0.6 mm.

15. The orthodontic hook of claim 9 wherein a fourth distance between the fourth extremity and the second extremity is at least 0.6 mm.
